(19) United States
(12) Patent Application Publication
(10) Pub. No.: US 2018/0045220 A1
(43) Pub. Date: Feb. 15, 2018

(54) FAN PROVIDED WITH STORAGE RACKS

(71) Applicant: JIANGMEN KEYE ELECTRIC APPLIANCES MANUFACTURING CO., LTD, Jiangmen City (CN)

(72) Inventors: XIANGMING HE, JIANGMEN CITY (CN); GUANGLIAN LIN, JIANGMEN CITY (CN)

(21) Appl. No.: 15/376,746

(22) Filed: Dec. 13, 2016

(30) Foreign Application Priority Data
Aug. 12, 2016 (CN) 201620877546.X

(51) Int. Cl. F04D 29/52; F21V 33/00; F04D 29/70; F04D 25/06; F04D 29/32; F21V 21/14; F04D 19/00

(52) U.S. Cl. CPC F04D 29/522; F21V 21/14; F21V 33/0096; F04D 19/002; F04D 25/06; F04D 29/325; F04D 29/703

(57) ABSTRACT

A fan provided with storage racks includes a supporting mechanism, a cylinder on the supporting mechanism, a front net cover and a rear net cover on the front end face and the rear end face of the cylinder correspondingly, fan blades in the cylinder, a motor in the cylinder to drive the fan blades to rotate, and a control device electrically connected with the motor. The storage racks are arranged on the outer wall of the cylinder, used for safely and conveniently storing small articles and conveniently dismounted and mounted and capable of being used more conveniently and folded or spread flatly during packaging and transportation, reducing packaging space, better avoiding collision damage during transportation, reducing packaging and transportation cost, and improving efficiency; furthermore, a rotatable lamp serving as an illuminating tool, line winding bars for sorting and storing power lines, and idler wheels for moving the fan conveniently are provided.

### CROSS-REFERENCE TO RELATED APPLICATION

This application claims priority to CN 201620877546.X, having a filing date of Aug. 12, 2016, the entire contents of which are hereby incorporated by reference.

### FIELD OF TECHNOLOGY

The following relates to a fan, in particular to a fan provided with storage racks.

### BACKGROUND

An electric fan is a domestic appliance according to which air circulation is accelerated by driving fan blades to rotate by means of a motor, and the electric fan is mainly used for summer heat relieving and air circulation, and widely applied to places such as homes, offices, stores, hospitals, hotels, etc.

Firstly, a fan in the known art is simple in function, it can only be used for supplying air, and cannot be used for storing articles and does not have an illuminating function neither; secondly, when the fan is not in use, the power line of the fan is generally placed on the ground freely, so that a passerby can stumble easily, and dangers are caused; thirdly, when the fan is large in size and quite heavy, the fan cannot be moved conveniently.

### SUMMARY

An aspect relates to a fan which can store articles and is convenient to mount and dismount and also convenient to package and transport.

The following is achieved by the following technical solution. The fan provided with storage racks includes a supporting mechanism, a cylinder installed on the supporting mechanism, a front net cover and a rear net cover arranged on the front end face and the rear end face of the cylinder correspondingly, fan blades arranged in the cylinder, a motor arranged in the cylinder and used for driving the fan blades to rotate, and a control device electrically connected with the motor; the storage racks are further arranged on the outer wall of the cylinder.

Further, the fan includes handles, one end of the storage racks is inserted with the cylinder, and the other end of the storage racks is erected on the handles.

Further, the number of the storage racks is two, and the two storage racks are symmetrically arranged on the two sides of the top of the cylinder.

Further, each storage rack includes a tray, installation components and a tray support, the tray is connected with the tray support through the installation components, and the tray support supports the tray to make the tray located on the horizontal plane.

Further, each tray is of a rectangular net structure formed by connecting parallel metal strips in a staggered mode; each tray is further provided with a cup holder, and the cup holder is concave downwards.

Further, downward-bent installation hooks are arranged at the two end corners of one side of each tray, and the installation hooks are inserted with the cylinder; the other opposite side of each tray is fixedly connected with the corresponding installation components.

Further, the number of the installation components of each storage rack is two, and the two end corners of one side of each tray are each fixedly connected with one installation component.

Further, each installation component includes a bearing part and a supporting part, the bearing part is fixedly connected with the bottom surface of the correspondingly tray, and a round hole matched with the corresponding tray support for installation is formed in the supporting part; vertical baffles are arranged on the two vertical edges of the supporting part correspondingly.

Further, each tray support includes a connection section and two installation sections with the same length, and the installation sections are perpendicularly fixed to the two ends of the connection section correspondingly; opposite hooks are arranged at the tail ends of the two installation sections, and the hooks are inserted into the round holes of the corresponding installation components correspondingly.

Further, the fan further includes a lamp rotatably arranged on the top of the cylinder, and line winding bars detachably fixed to the handles; the supporting mechanism includes two supporting frames, a fixed part and a movable part; each supporting frame includes a connection part and side parts perpendicularly fixed to the two ends of the connection part, the side parts are fixedly connected to the two sides of the cylinder correspondingly, and an included angle is formed between the two supporting frames; the two ends of the fixed part and the two ends of the movable part are fixedly connected with the connection parts of the two supporting frames correspondingly, and idler wheels are arranged on the movable part.

According to the fan provided with storage racks of embodiments of the present invention, the storage racks which can store small articles safely and conveniently are provided. The storage racks are convenient to dismount and mount and capable of being used more conveniently and folded or spread flatly during packaging and transportation, reducing packaging space, better avoiding collision damage during transportation, reducing packaging and transportation cost, and improving efficiency; furthermore, a rotatable lamp is provided to serve as an illuminating tool; furthermore, line winding bars are arranged for sorting and storing power lines, and idler wheels are arranged for moving the fan conveniently.

For better understanding and implementation, embodiments of the present invention will be described in details with reference to the following drawings.

### BRIEF DESCRIPTION OF THE DRAWINGS

Some of the embodiments will be described in detail, with reference to the following figures, wherein like designations denote like members, wherein:

FIG. 1 is a solid diagram of a fan of embodiments of the present invention;

FIG. 2 is a solid diagram of a storage rack of embodiments of the present invention;

FIG. 3 is a solid diagram of an installation component of embodiments of the present invention; and

FIG. 4 is a front view of a tray support of embodiments of the present invention.

### DETAILED DESCRIPTION OF THE EMBODIMENTS

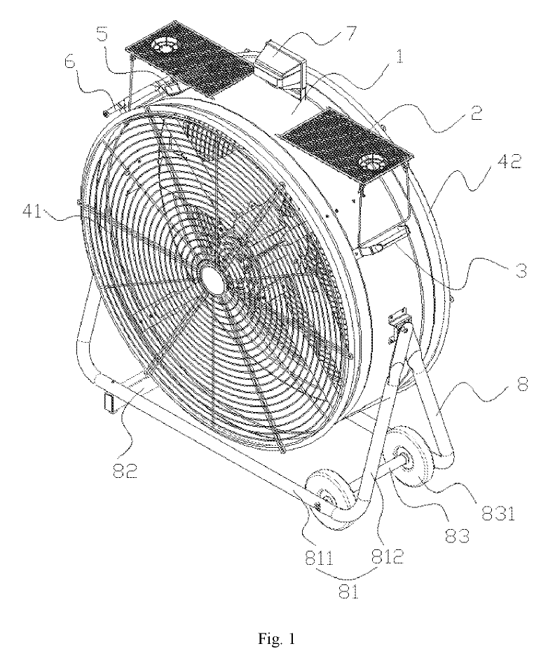

Please refer to FIG. 1 which is the solid diagram of a fan of embodiments of the present invention. The fan provided with storage racks of embodiments of the present invention includes a cylinder 1, storage racks 2, handles 3, a front net cover 41, a rear net cover 42, fan blades, a motor, a control device 5, line winding bars 6, a lamp 7 and a supporting mechanism 8, wherein the cylinder 1 is installed on the supporting mechanism 8, the front net cover 41 and the rear net cover 42 are installed on the front end face and the rear end face of the cylinder 1 correspondingly, the fan blades are arranged in the cylinder 1, the fan blades are connected with the motor and driven by the motor, the control device 5 is electrically connected with the motor and fixed to the outer wall of the cylinder 1, and the storage racks 2, the handles 3, the line winding bars 6 and the lamp 7 are also arranged on the outer wall of the cylinder 1.

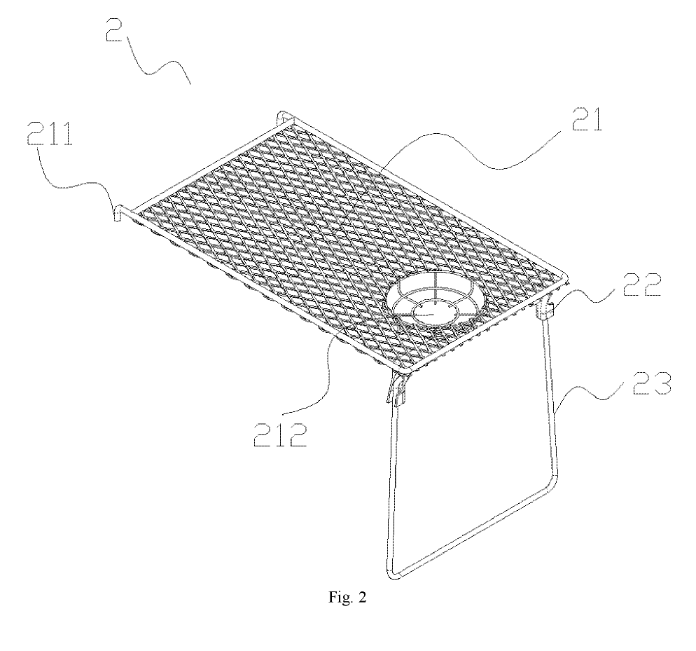

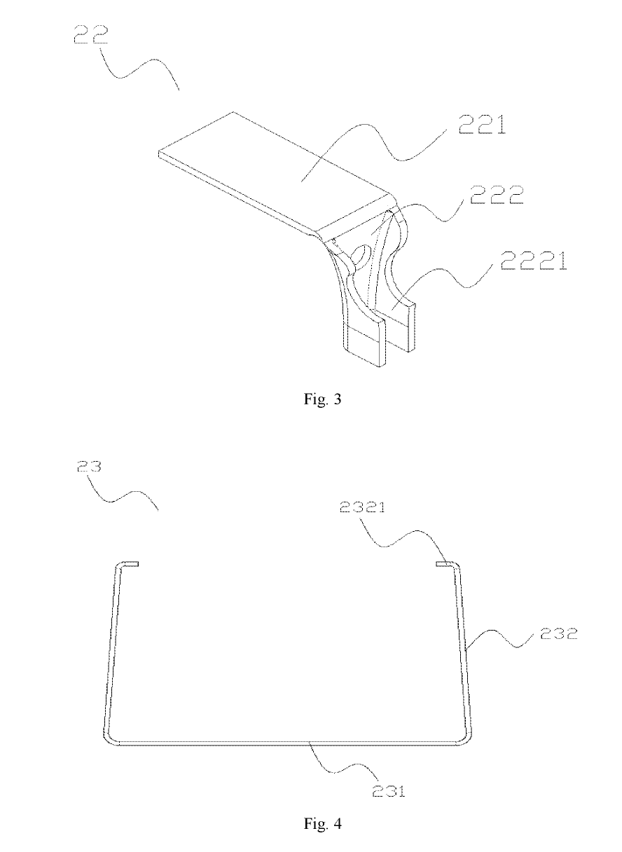

The cylinder 1 is a hollow cylinder, the two handles 3 are symmetrically fixed to the two sides of the top of the cylinder 1, the number of the storage racks 2 is two, and the two storage racks 2 are symmetrically arranged on the two sides of the top of the cylinder 1. One of the ends of the storage racks 2 are inserted with the cylinder 1, and the other ends of the storage racks 2 are erected on the handles 3. Please refer to FIG. 2 which is the solid diagram of the storage rack of embodiments of the present invention. Each storage rack 2 includes a tray 21, installation components 22 and a tray support 23, wherein the tray 21 is of a rectangular net structure which is formed by welding parallel metal bars in a staggered mode. The trays are not limited by the above form, can be trapezoidal, square and the like, and can also be of flat plate structures besides the net structures, the structures such as leak holes are arranged on the flat plates, and the trays can be made of plastic and the like. A round cup holder 212 is further arranged on each tray 21, and the cup holders 212 are concave downwards and can be used for holding the articles such as cups and kettles. Downward-bent installation hooks 211 are arranged at the two end corners of one side of each tray 21, the installation hooks 211 are inserted into corresponding installation holes in the cylinder 1, and the two end corners of the other opposite side of the tray 21 are fixedly connected with the installation components 22 correspondingly. Please refer to FIG. 3 which is the solid diagram of the installation component of embodiments of the present invention. The number of the installation components 22 of each storage rack is two, and each installation component 22 includes a bearing part 221 and a supporting part 222. The bearing parts 221 are rectangular sheets and are welded to the bottom surfaces of the trays 21. The supporting parts 222 are approximately trapezoidal sheets, and round holes are formed in the supporting parts 222; the ends of the supporting parts 222 are fixedly connected with the ends of the bearing parts 221, and the supporting parts 222 are made approximately perpendicular to the bearing parts 221. Vertical baffles 2221 are arranged on the two vertical edges of each supporting part 222 correspondingly. Please refer to FIG. 4 which is the front view of the tray support of embodiments of the present invention. Each tray support 23 is approximately in a U shape, is made of a material with certain elasticity and includes a connection section 231 and installation sections 232 which are perpendicularly fixed to the two ends of the connection section 231 correspondingly, and the two installation sections 232 have the same length. Opposite hooks 2321 are arranged at the tail ends of the installation sections 232; during installation, the two installation sections 232 of each tray support 23 are pulled away, and then the hooks 2321 are inserted into the round holes of the supporting parts 222 of the corresponding installation components 22, so that the tray support 23 and the corresponding installation components 22 are fixedly connected. The baffles 2221 can prevent the installation sections 232 from rotating, so that the tray supports 23 are made approximately perpendicular to the trays 21. The tray supports 23 are directly erected on the handles 3, and the trays 21 are supported and made approximately in the state of being parallel to the ground, so that articles can be stored in the trays 21 conveniently. The whole storage racks 2 can be mounted and dismounted easily and conveniently, and when the storage racks are not in use, the storage racks can be directly taken down only with hands quite conveniently and rapidly without the assistance of the tools such as a screwdriver and a spanner. During packaging and transportation, the storage racks 2 can be dismounted from the fan, and then the tray supports 23 can also be dismounted from the storage racks 2 so that the storage racks 2 can be folded or spread flatly, the packaging space is reduced, collision damage during transportation is better avoided, the packaging and transportation cost is reduced, and the efficiency is improved.

A capacitor and a switch are arranged in the control device 5, and both the capacitor and the switch are electrically connected with the motor. The control device 5 is fixed to the outer wall of the cylinder 1 and is close to one handle 3, and the control device 5 is also electrically connected with a power line. The handles 3 are provided with hollow parts, and the line winding bars 6 can penetrate through the hollow parts to be fixed to the handles 3. When the fan is not in use, the power line can be wound on the line winding bars 6, so that the power line is sorted and placed conveniently. The lamp 7 is rotatably fixed to the top of the cylinder 1 and connected with a power source through an independent power line or electrically connected with the control device 5 through an independent switch. When illumination is needed, the lamp 7 can be turned on, and the illuminating angle of the lamp 7 can be adjusted.

The supporting mechanism 8 includes supporting frames 81, a fixed part 82 and a movable part 83. Each supporting frame 81 is approximately in a U shape and is provided with a connection part 811 and side parts 812 which are perpendicularly fixed to the two ends of the connection part 811, wherein the side parts 812 are fixed to the outer walls of the two sides of the cylinder 1 correspondingly. The ends of the side parts 812, fixed to the same side of the cylinder 1, of the two supporting frames 81 are fixed to the same position on the outer wall of the cylinder 1, and an acute included angle is formed between the two side parts 812, so that the cylinder 1 is supported by the two supporting frames 81. The two ends of the fixed part 82 and the two ends of the movable part 83 are fixedly connected with the two ends of the connection parts 811 of the two supporting frames 81 correspondingly, so that a triangular stable supporting structure is formed by the fixed part 82, the movable part 83 and the two supporting frames 81. The fixed part 82 is fixed under the connection parts 811 of the supporting frames 81 and makes contact with the ground, and the movable part 83 and the connection parts 811 of the supporting frames 81 are located on the same horizontal plane; idler wheels 831 are further installed on the movable part 83, and the idler wheels 831 make contact with the ground. The number of the idler wheels 831 can be one or more; in the embodiment, the number of the idler wheels 831 is two, and the two idler wheels 831 are fixed to the two ends of the movable part 83 correspondingly. When the fan needs to be moved, a user can hold the handles to lift up one side of the fan and pull the fan to roll on the ground by means of the idler wheels 831, and thus the fan is transferred to another position conveniently and effortlessly.

According to the fan provided with the storage racks of embodiments of the present invention, the storage racks which can store small articles safely and conveniently can be provided, the storage racks are convenient to dismounted and mounted, capable of being used more conveniently, and folded or spread flatly during packaging and transportation, reducing packaging space, better avoiding collision damage during transportation, reducing packaging and transportation cost, and improving efficiency; furthermore, the rotatable lamp is provided to serve as the illuminating tool; furthermore, the line winding bars are arranged for sorting and storing the power lines, and the idler wheels are arranged for moving the fan conveniently.

Although the present invention has been disclosed in the form of preferred embodiments and variations thereon, it will be understood that numerous additional modifications and variations could be made thereto without departing from the scope of the invention.

For the sake of clarity, it is to be understood that the use of ‘a’ or ‘an’ throughout this application does not exclude a plurality, and ‘comprising’ does not exclude other steps or elements.

1-10. (canceled)

11. A fan provided with storage racks, comprising: wherein the fan includes a supporting mechanism, a cylinder installed on the supporting mechanism, a front net cover and a rear net cover arranged on a front end face and a rear end face of the cylinder correspondingly, fan blades arranged in the cylinder, a motor arranged in the cylinder and used for driving the fan blades to rotate, and a control device electrically connected with the motor; the storage racks are further arranged on an outer wall of the cylinder.

12. The fan provided with the storage racks according to claim 11, wherein the fan further includes handles, one end of the storage racks is inserted with the cylinder, and the other end of the storage racks is erected on the handles.

13. The fan provided with the storage racks according to claim 11, wherein a number of the storage racks is two, and the two storage racks are symmetrically arranged on two sides of a top of the cylinder.

14. The fan provided with storage racks according to any of claim 11, wherein each storage rack includes a tray, installation components and a tray support, the tray is connected with the tray support through the installation components, and the tray support supports the tray to make the tray located on a horizontal plane.

15. The fan provided with storage racks according to any of claim 12, wherein each storage rack includes a tray, installation components and a tray support, the tray is connected with the tray support through the installation components, and the tray support supports the tray to make the tray located on a horizontal plane.

16. The fan provided with storage racks according to any of claim 13, wherein each storage rack includes a tray, installation components and a tray support, the tray is connected with the tray support through the installation components, and the tray support supports the tray to make the tray located on a horizontal plane.

17. The fan provided with storage racks according to claim 14, wherein each tray is of a rectangular net structure formed by connecting parallel metal strips in a staggered mode;
each tray is further provided with a cup holder, and the cup holder is concave downwards.

18. The fan provided with storage racks according to claim 15, wherein each tray is of a rectangular net structure formed by connecting parallel metal strips in a staggered mode;
each tray is further provided with a cup holder, and the cup holder is concave downwards.

19. The fan provided with storage racks according to claim 16, wherein each tray is of a rectangular net structure formed by connecting parallel metal strips in a staggered mode;
each tray is further provided with a cup holder, and the cup holder is concave downwards.

20. The fan provided with storage racks according to claim 14, characterized in that downward-bent installation hooks are arranged at two end corners of one side of each tray, and the installation hooks are inserted with the cylinder; the other opposite side of each tray is fixedly connected with the corresponding installation components.

21. The fan provided with storage racks according to claim 15, wherein downward-bent installation hooks are arranged at two end corners of one side of each tray, and the installation hooks are inserted with the cylinder; the other opposite side of each tray is fixedly connected with the corresponding installation components.

22. The fan provided with storage racks according to claim 16, wherein downward-bent installation hooks are arranged at two end corners of one side of each tray, and the installation hooks are inserted with the cylinder; the other opposite side of each tray is fixedly connected with the corresponding installation components.

23. The fan provided with storage racks according to claim 20, wherein the number of the installation components of each storage rack is two, and the two end corners of one side of each tray are each fixedly connected with one installation component.

24. The fan provided with storage racks according to claim 23, wherein each installation component includes a bearing part and a supporting part, the bearing part is fixedly connected with a bottom surface of the correspondingly tray, and a round hole matched with the corresponding tray support for installation is formed in the supporting part; vertical baffles are arranged on two vertical edges of the supporting part correspondingly.

25. The fan provided with storage racks according to claim 24, wherein each tray support includes a connection section and two installation sections with the same length, and the installation sections are perpendicularly fixed to the two ends of the connection section correspondingly; opposite hooks are arranged at the tail ends of the two installation sections, and the hooks are inserted into the round holes of the corresponding installation components correspondingly.

26. The fan provided with storage racks according to claim 14, wherein the fan further includes a lamp rotatably arranged on a top of the cylinder, and line winding bars detachably fixed to the handles; the supporting mechanism includes two supporting frames, a fixed part and a movable part; each supporting frame includes a connection part and side parts perpendicularly fixed to the two ends of the connection part, the side parts are fixedly connected to the two sides of the cylinder correspondingly, and an included angle is formed between the two supporting frames; the two ends of the fixed part and the two ends of the movable part are fixedly connected with the connection parts of the two supporting frames correspondingly, and idler wheels are arranged on the movable part.

27. The fan provided with storage racks according to claim 15, wherein that the fan further includes a lamp rotatably arranged on a top of the cylinder, and line winding bars detachably fixed to the handles; the supporting mechanism includes two supporting frames, a fixed part and a movable part; each supporting frame includes a connection part and side parts perpendicularly fixed to the two ends of the connection part, the side parts are fixedly connected to the two sides of the cylinder correspondingly, and an included angle is formed between the two supporting frames; the two ends of the fixed part and the two ends of the movable part are fixedly connected with the connection parts of the two supporting frames correspondingly, and idler wheels are arranged on the movable part.

28. The fan provided with storage racks according to claim 16, wherein the fan further includes a lamp rotatably arranged on the top of a cylinder, and line winding bars detachably fixed to the handles; the supporting mechanism includes two supporting frames, a fixed part and a movable part; each supporting frame includes a connection part and side parts perpendicularly fixed to the two ends of the connection part, the side parts are fixedly connected to the two sides of the cylinder correspondingly, and an included angle is formed between the two supporting frames; the two ends of the fixed part and the two ends of the movable part are fixedly connected with the connection parts of the two supporting frames correspondingly, and idler wheels are arranged on the movable part.
